(19) United States
(12) Patent Application Publication
(10) Pub. No.: US 2023/0319604 A1
(43) Pub. Date: Oct. 5, 2023

(54) SLAVE STATION SYSTEM

(71) Applicant: NIPPON TELEGRAPH AND TELEPHONE CORPORATION, Tokyo (JP)

(72) Inventors: Hiroko NOMURA, Musashino-shi, Tokyo (JP); Hirofumi YAMAMOTO, Musashino-shi, Tokyo (JP); Keita TAKAHASHI, Musashino-shi, Tokyo (JP)

(73) Assignee: NIPPON TELEGRAPH AND TELEPHONE CORPORATION, Tokyo (JP)

(21) Appl. No.: 18/022,607

(22) PCT Filed: Aug. 27, 2020
(86) PCT No.: PCT/JP2020/032481

§ 371 Date: Feb. 22, 2023

(51) Int. Cl. H04W 24/04

(52) U.S. Cl. CPC H04W 24/04; H04W 88/08

(57) ABSTRACT

A slave station system 2 includes a first individual function unit 11a connected to a first master station device 3a and corresponding to the first master station device 3a, a second individual function unit 11b connected to a second master station device 3b and corresponding to the second master station device 3b, and a common function unit 21 connected to the first individual function unit 11a and the second individual function unit 11b and functioning regardless of the types of a plurality of master station devices. The first individual function unit 11a and the second individual function unit 11b are mounted on the same shared slave station device 10. The first individual function unit 11a and the second individual function unit 11b are configured to be operable independently of each other. The first individual function unit 11a includes a restoration function operated at least either manually or dynamically. The second individual function unit 11b includes a restoration function operated at least either manually or dynamically.

### TECHNICAL FIELD

The present disclosure relates to a slave station system.

### BACKGROUND ART

There has conventionally been a base station device comprising a master station device and a slave station device. NPL 1 relates to the study and promotion of infrastructure sharing in which a base station device, antennas and the like of a plurality of MNO (Mobile Network Operators) are shared.

### CITATION LIST

### Non Patent Literature

NPL 1: Guidelines on the application relation of telecommunication business and radio wave methods related to infrastructure sharing in the mobile communication field, December 2018, Ministry of Internal Affairs and Communications

### SUMMARY OF INVENTION

### Technical Problem

The infrastructure sharing disclosed in NPL 1 proposes to share all devices including the base station device. In such a case, however, when an abnormality occurs in the shared devices, the abnormality impacts the communication systems provided by not only a specific MNO but also all the MNOs.

The present disclosure has been contrived in order to solve the foregoing problem. An object of the present disclosure is to obtain a slave station system that is capable of suppressing an impact resulting from the occurrence of a failure and an abnormality when devices constituting a communication system are shared.

### Solution to Problem

A slave station system according to the present disclosure is a slave station system connected to a plurality of master station devices including at least a first master station device and a second master station device different from the first master station device, the slave station system including: a first individual function unit connected to the first master station device and corresponding to the first master station device; a second individual function unit connected to the second master station device and corresponding to the second master station device; and a common function unit connected to the first individual function unit and the second individual function unit and functioning regardless of the types of the plurality of master station devices. The first individual function unit and the second individual function unit are mounted on the same slave station device. The first individual function unit and the second individual function unit are configured to be operable independently of each other. The first individual function unit includes a restoration function operated at least either manually or automatically. The second individual function unit includes a restoration function operated at least either manually or automatically.

### Advantageous Effects of Invention

The present disclosure can obtain a slave station system that is capable of suppressing an impact resulting from the occurrence of a failure and an abnormality when devices constituting a communication system are shared.

### BRIEF DESCRIPTION OF DRAWINGS

FIG. 1 is a diagram schematically showing an entire configuration of a communication system according to Embodiment 1.

FIG. 2 is a diagram showing a communication system according to a comparative example.

FIG. 3 is a diagram showing a modification of the communication system according to Embodiment 1.

### DESCRIPTION OF EMBODIMENTS

Embodiments will be described with reference to the accompanying drawings. The same reference numerals in each diagram denote the same or corresponding parts. In the present disclosure, repeated descriptions will be appropriately simplified or omitted. Furthermore, the present disclosure is not limited to the following embodiments. The present disclosure may include various modifications and combinations of configurations disclosed in the following embodiments without departing from the spirit thereof.

### Embodiment 1

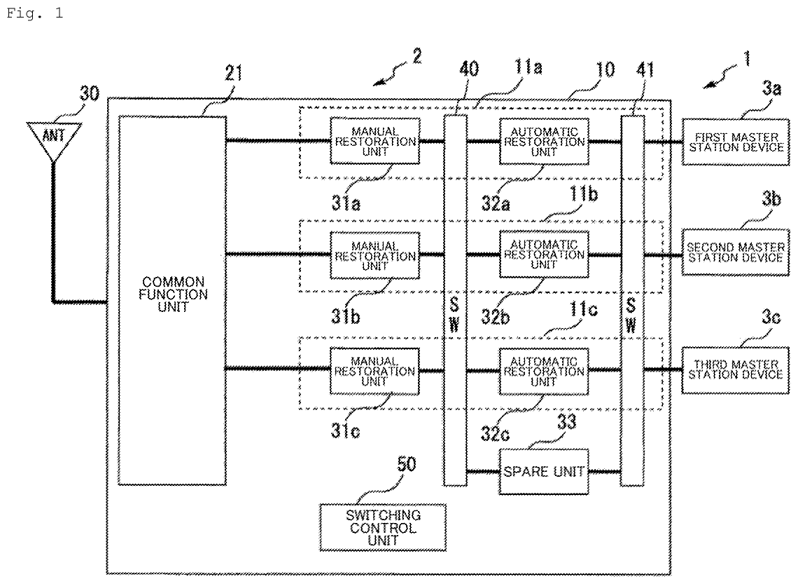

FIG. 1 is a diagram schematically showing an entire configuration of a communication system 1 according to Embodiment 1. The communication system 1 includes a plurality of master station devices and a slave station system 2 connected to the plurality of master station devices. The slave station system 2 is installed away from each of the master station devices. The slave station system 2 communicates with each of the master station devices.

The plurality of master station devices include at least a first master station device 3a and a second master station device 3b different from the first master station device 3a. The number of the plurality of master station devices to which the slave station system 2 is connected may be three or more. In the illustrated example, the plurality of master station devices to which the slave station system 2 is connected include a third master station device 3c different from the first master station device 3a and the second master station device 3b.

For example, when the communication system 1 is applied to a mobile base station that provides wireless communication, each master station device is equipped with functions of a CU (Centralized Unit) and a DU (Distributed UNIT) of each MNO (Mobile Network Operator). When the communication system 1 is applied to a mobile base station, the slave station system 2 is equipped with a function of a RU (Radio Unit). The CU and the DU constituting the mobile base station perform digital signal processing, and the RU converts a digital signal into a radio signal. The radio signal is radiated by an antenna in a predetermined target direction.

The slave station system 2 according to the present embodiment can be applied not only to a mobile base station that provides wireless communication, but also to various communication systems 1. The slave station system 2 can be applied to a wireless communication system utilizing, for example, 5G, local 5G, LTE, and various wireless LANs, and to a wired communication system. The slave station system 2 can be applied to any communication system 1 composed of a master station device and a slave station device.

The slave station system 2 and the plurality of master station devices are physically connected by, for example, physical media such as single-core optical fibers or multi-core fibers in the same number as the master station devices. The slave station system 2 and the plurality of master station devices may be connected via, for example, a transmission device such as a WDM device provided between the slave station system 2 and the plurality of master station devices. The connection between the slave station system 2 and the plurality of master station devices may be logically separated by, for example, a VLAN or the like.

The slave station system 2 includes, for example, one slave station device. Specifically, the slave station system 2 includes a shared antenna 30 and a shared slave station device 10 connected to the plurality of master station devices. The shared antenna 30 is an antenna that functions regardless of the types of the master station devices.

The shared slave station device 10 is equipped with at least a first individual function unit 11a corresponding to the first master station device 3a and a second individual function unit 11b corresponding to the second master station device 3b. The first individual function unit 11a and the second individual function unit 11b are mounted on the same slave station device. In the illustrated example, the shared slave station device 10 is further equipped with a third individual function unit 11c corresponding to the third master station device 3c. The slave station system 2 is provided with individual function units in the same number as the number of master station devices to which the slave station system 2 is connected. The number of master station devices to which the slave station system 2 is connected may be any number of two or more. The number of individual function units provided in the slave station system 2 may be any number of two or more. The plurality of individual function units are housed in the same housing, for example.

The first individual function unit 11a is connected to the first master station device 3a. The second individual function unit 11b is connected to the second master station device 3b. The third individual function unit 11c is connected to the third master station device 3c.

The individual function units according to the present disclosure each have a function that require individual management, setting, control, and the like for each master station device, out of the functions of the conventional slave station devices. When the slave station system 2 is applied to a mobile base station, the individual function units each have a function requiring individual management, setting, control, and the like for each MNO, out of functions of a conventional RU.

In the present embodiment, the individual function units are configured to be operable independently of each other. Even if an abnormality related to one of the plurality of individual function units occurs, the abnormality does not impact the other individual function units. For example, even if the first individual function unit 11a fails, the failure does not impact communication performed by the second master station device 3b and the third master station device 3c. Even when an abnormality occurs in connection and communication between the first master station device 3a and the first individual function unit 11a, communication performed by the second master station device 3b and the third master station device 3c does not impact the second individual function unit 11b and the third individual function unit 11c.

In the present embodiment, the shared slave station device 10 is equipped with a common function unit 21. The common function unit 21 is housed in the same housing as the individual function unit, for example. In the present embodiment, the common function unit 21 is mounted on the same slave station device as the slave station device on which the first individual function unit 11a and the second individual function unit 11b are mounted.

The common function unit 21 has a common function which does not depend on individual setting or the like for each master station device, out of the functions of the conventional slave station devices. The common function unit 21 is connected to the first individual function unit 11a and the second individual function unit 11b. As shown in the diagram, the common function unit 21 may be connected to the third individual function unit 11c. In the illustrated example, the common function unit 21 communicates with the first individual function unit 11a, the second individual function unit 11b, and the third individual function unit 11c.

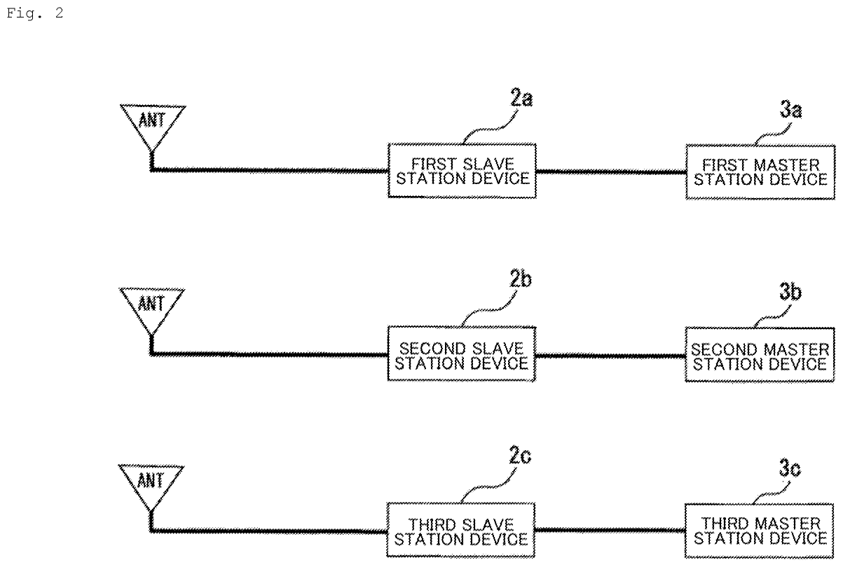

FIG. 2 is a diagram showing a communication system according to a comparative example. The comparative example shown in FIG. 2 schematically shows the configuration of a conventional mobile base station in which devices are not shared. The conventional mobile base station shown in FIG. 2 is provided with a first slave station device 2a, a second slave station device 2b, and a third slave station device 2c. In the comparative example shown in FIG. 2, individual antennas are connected to each of the slave station devices. The first slave station device 2a, the second slave station device 2b, and the third slave station device 2c have common functions independent of a master station. The first slave station device 2a, the second slave station device 2b, and the third slave station device 2c have, as the common functions independent of the master station, for example, an antenna control function (e.g., a tilt angle control function), a power amplifier function, a function of a power supply unit for antenna control, and various other functions. The common function unit 21 according to the present embodiment has a function that is commonly held by the conventional slave station devices described above.

A specific example of functions of the individual function units and the common function unit 21 when the slave station system 2 is applied to the mobile base station will now be described. The functions of the individual function units and the common function unit 21 according to the present disclosure are not limited to the following examples.

For example, the slave station system 2 acquires reference definition information from each master station device in order to exchange hardware management information for managing hardware, such as an antenna, with each master station device. Also in the conventional example shown in FIG. 2, each slave station device acquires reference definition information from the master station. In the conventional example shown in FIG. 2, the reference definition information includes common reference definition information independent of the types of the master station devices. For example, the common function unit 21 has a function of acquiring the common reference definition information shown in the conventional example in FIG. 2. The common function unit 21 has a function of operating on the basis of the acquired common reference definition information, such as, for example, a function of controlling hardware such as the shared antenna 30.

Information necessary for the antenna to radiate a predetermined radio wave includes, for example, a radio wave output value, radio wave formation information, antenna calibration data, and the like. For example, the common function unit 21 has a function of acquiring various information described above from each master station device by means of a common protocol such as NETCONF (Network Configuration Protocol). The common function unit 21 has a function of controlling hardware such as the shared antenna 30 by using a common protocol such as HDLC (Height-Level Data Link Control).

In order for the slave station system 2 to acquire the hardware control information from each master station device, the network configuration is different for each MNO to which each master station device belongs, so that the slave station system 2 needs to operate while absorbing the difference in the network configuration. The difference in the network configuration here means, for example, a difference among a MAC address, a VLAN ID, a network protocol, and an encryption protocol, a difference in physical connection systems between the slave station system 2 and the master station devices. Each individual function unit provided in the slave station system 2 has a role of absorbing the difference in the network configuration described above. More specifically, for example, storage media such as memories in which connection information on connection with the master station devices and program corresponding to the master station devices are stored, correspond to the individual function units. The individual function units also correspond to, for example, physical interfaces for connecting to the master station devices.

As described above, the slave station system 2 according to the present embodiment includes: the first individual function unit 11a connected to the first master station device 3a and corresponding to the first master station device 3a; the second individual function unit 11b connected to the second master station device 3b and corresponding to the second master station device 3b; and the common function unit 21 connected to the first individual function unit 11a and the second individual function unit 11b and functioning regardless of the types of the plurality of master station devices. The first individual function unit 11a and the second individual function unit 11b are mounted on the same shared slave station device 10. The first individual function unit 11a and the second individual function unit 11b are configured to be operable independently of each other. When the first individual function unit 11a or the first master station device 3a fails, an abnormality in communication between the first individual function unit 11a and the first master station device 3a does not impact communication performed by the second master station device 3b. In the present embodiment, for example, even if a failure or abnormality occurs in a specific MNO, such failure or abnormality does not impact the other MNOs. Thus, the slave station system 2 and the shared slave station device constituting the slave station system 2 can be shared.

In the example shown in FIG. 1, the common function unit 21 is mounted on the shared slave station device 10 on which the first individual function unit 11a and the second individual function unit 11b are mounted. According to such a configuration, the functions of a plurality of slave station devices in the conventional example shown in FIG. 2 can be realized by one shared slave station device 10.

The slave station system 2 according to the present embodiment includes the common function unit 21 having a common function independent of the individual settings of the master station devices, so that the same shared antenna 30 can be used for the plurality of master station devices. According to the present embodiment, for example, the infrastructure of a steel tower can be shared by the MNOs as the shared antenna 30. For example, a plurality of antennas required in the conventional example shown in FIG. 2 can be combined into one shared antenna 30.

Note that the common function unit 21 may be housed in a housing different from the housing in which the individual function units are housed. That is, the common function unit 21 may be mounted on a device different from the shared slave station device 10 on which the individual function units are mounted. In this case, the functions of three or more slave station devices as in the conventional example shown in FIG. 2 can be realized by at least two devices.

Further, in the present embodiment, the first individual function unit 11a includes a restoration function operated at least either manually or automatically. A restoration operation performed by the first individual function unit 11a does not impact the second individual function unit 11b and the third individual function unit 11c. A restoration operation performed by the first individual function unit 11a does not impact communication performed by the second master station device 3b and the third master station device 3c. Similarly to the first individual function unit 11a, the second individual function unit 11b also includes a restoration function. It is more preferred that the third individual function unit 11c also include a restoration function. The common function unit 21 may also include a restoration function.

A specific example of the configuration of the individual function units having a restoration function is described with reference to FIG. 1. The first individual function unit 11a includes, for example, a manual restoration unit 31a and an automatic restoration unit 32a. The second individual function unit 11b includes, for example, a manual restoration unit 31b and an automatic restoration unit 32b. The third individual function unit 11c includes, for example, a manual restoration unit 31c and an automatic restoration unit 32c.

The slave station system 2 includes a spare unit 33. The spare unit 33 functions as a spare of the automatic restoration unit 32a. The spare unit 33 may function as a spare of the automatic restoration unit 32b and the automatic restoration unit 32c. That is, the spare unit 33 may be shared by the individual function units. A component or a function different from the spare unit 33 may be mounted as a spare of the automatic restoration unit 32b and the automatic restoration unit 32c.

In the present embodiment, the slave station system 2 includes a switch unit 40 provided between the automatic restoration unit and the manual restoration unit, and a switch unit 41 provided between the master station device and the automatic restoration unit. The slave station system 2 also includes a switching control unit 50. The switching control unit 50 controls, for example, each of the automatic restoration units, a switch unit 40, a switch unit 41, and the like. Although not shown in the diagrams, the switching control unit 50 is connected to each unit to be controlled, such as each automatic restoration unit, the switch unit 40, the switch unit 41, and the like. The switch unit 40, the switch unit 41, and the switching control unit 50 may be provided outside the shared slave station device 10.

For example, when the automatic restoration unit 32a fails, the switching control unit 50 causes the automatic restoration unit 32a to execute a switching operation of switching the function to the spare unit 33. For example, when the automatic restoration unit 32a fails, the switching control unit 50 causes the switch unit 40 to switch the connection between the automatic restoration unit 32a and the manual restoration unit 31a to the connection between the spare unit 33 and the manual restoration unit 31a. For example, when the automatic restoration unit 32a fails, the switching control unit 50 causes the switch unit 41 to switch the connection between the automatic restoration unit 32a and the first master station device 3a to the connection between the spare unit 33 and the first master station device 3a. Similarly, the switching control unit 50 performs various types of control even when the automatic restoration unit 32b or the automatic restoration unit 32c fails. Each automatic restoration unit notifies the switching control unit 50 of the operation status. The switching control unit 50 performs various types of control described above in accordance with the contents of the operation status notification from each automatic restoration unit. The switching control unit 50 may include a function of issuing an alert when a failure occurs in each automatic restoration unit. The switching control unit 50 may also include a function of issuing an alert when a failure occurs in the switch unit 40 and the switch unit 41.

As described above, the automatic restoration units are each a part capable of performing an automatic restoration operation. For example, a specific area of a storage medium such as a memory in which connection information on connection with the master station devices and a program are stored, corresponds to the automatic restoration units. For example, the automatic restoration units each have a function of developing the area into a spare area when a failure occurs in the area. The spare unit 33 corresponds to this spare area.

The manual restoration units are each a part corresponding to manual restoration such as component replacement. For example, a component such as a physical interface for connecting each unit, which requires replacement by site dispatch at the time of a failure, corresponds to a manual restoration unit. The manual restoration units are configured to be replaceable (pluggable). For example, replacing the manual restoration unit 31a does not impact the second individual function unit lib and the third individual function unit 11c.

The switching control unit 50 may be connected to the manual restoration units. Similarly to the automatic restoration units, the manual restoration units may each have a function of notifying the switching control unit 50 of an operation status. The switching control unit 50 may each have a function of issuing an alert when a failure occurs in each manual restoration unit.

According to the slave station system 2 constructed as described above, the impact of the occurrence of a failure or an abnormality can be suppressed. The maintenance work performed when a failure occurs is desirably performed as infrequently as possible. Therefore, it is preferred that the common function unit 21 that impacts the entire communication system 1 be composed of components that fail as infrequently as possible. The components constituting the common function unit 21 are preferably, for example, components that fail less frequently as compared with the manual restoration units and the automatic restoration units. Further, the components constituting the manual restoration units requiring replacement are preferably components that fail less frequently as compared with the automatic restoration units.

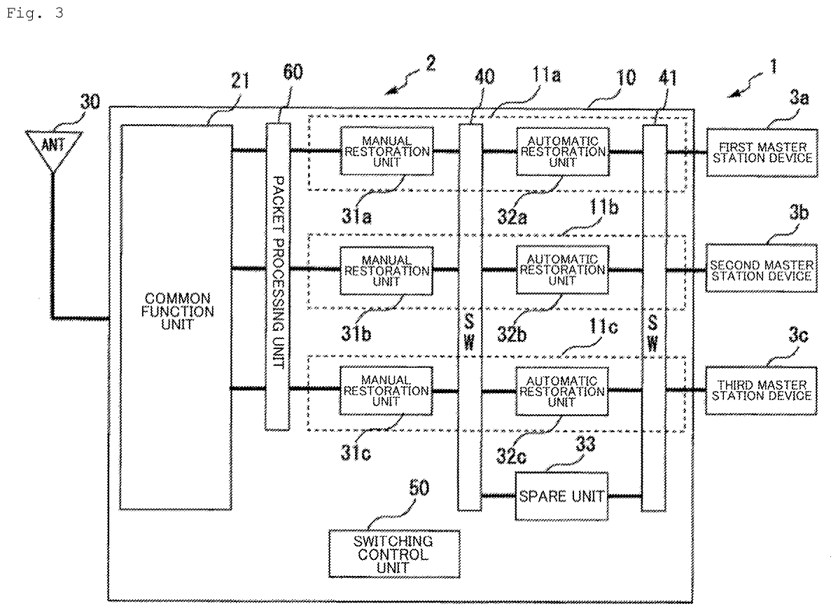

FIG. 3 is a diagram showing a modification of the communication system 1 according to Embodiment 2. In the present modification, the slave station system 2 includes a packet processing unit 60. The packet processing unit 60 can be installed at any location. The packet processing unit 60 may be installed inside or outside the shared slave station device 10. The packet processing unit 60 can be installed at any position between the master station device and the common function unit 21. Further, the packet processing unit 60 may be composed of devices installed at a plurality of locations.

The packet processing unit 60 functions as an abnormal signal inflow prevention unit for preventing abnormal signal inflow from the master station device to the common function unit. Although not shown, in the present modification, the switching control unit 50 is connected to the packet processing unit 60. For example, the switching control unit 50 monitors an inflow state of traffic to the packet processing unit 60. The switching control unit 50 issues an alert when detecting inflow of an abnormal packet or inflow of excessive traffic from the master station device. When the switching control unit 50 detects inflow of an abnormal packet or inflow of excessive traffic from the master station device, the switching control unit 50 causes the packet processing unit 60 to discard the packet that has flowed in. According to the present modification, preventing abnormal signal inflow to the common function unit 21 can prevent a failure of the common function unit 21. The switching control unit 50 may include a function of issuing an alert when a failure occurs in the packet processing unit 60.

The functions of the respective units constituting the slave station system 2 according to the foregoing embodiments may be realized by using dedicated hardware or may be realized by a combination of dedicated hardware and software. Specifically, the functions of the respective units are realized by a controller or the like for performing information processing. Typically, the controller includes a processor and a memory. The memory includes a volatile memory or a nonvolatile memory. The various functions described above are realized by the processor executing a control program stored in the memory. The control program may be recorded in a computer-readable recording medium. The controller may be realized with use of hardware such as an ASIC (Application Specific Integrated Circuit), a PLD (Programmable Logic Device), or an FPGA (Field Programmable Gate Array).

### INDUSTRIAL APPLICABILITY

The slave station system according to the present disclosure can be applied to, for example, a mobile base station that provides wireless communication.

### REFERENCE SIGNS LIST

1 Communication system
2 Slave station system
2a First slave station device
2b Second slave station device
2c Third slave station device
3a First master station device
3b Second master station device
3c Third master station device
10 Shared slave station device
11a First individual function unit
11b Second individual function unit
11c Third individual function unit
21 Common function unit
30 Shared antenna
31a Manual restoration unit
31b Manual restoration unit
31c Manual restoration unit
32a Automatic restoration unit
32b Automatic restoration unit
32c Automatic restoration unit
33 Spare unit
40 Switch unit
41 Switch unit
50 Switching control unit
60 Packet processing unit

1. A slave station system is a slave station system connected to a plurality of master station devices including at least a first master station device and a second master station device different from the first master station device, the slave station system comprising: a first individual function unit connected to the first master station device and corresponding to the first master station device; a second individual function unit connected to the second master station device and corresponding to the second master station device; and a common function unit connected to the first individual function unit and the second individual function unit and functioning regardless of types of the plurality of master station devices, wherein the first individual function unit and the second individual function unit are mounted on the same slave station device, the first individual function unit and the second individual function unit are configured to be operable independently of each other, the first individual function unit includes a restoration function operated at least either manually or automatically, and the second individual function unit includes a restoration function operated at least either manually or automatically.

2. The slave station system according to claim 1, wherein the common function unit is mounted on the same slave station device as the slave station device on which the first individual function unit and the second individual function unit are mounted.

3. The slave station system according to claim 1, wherein the common function unit is connected to a shared antenna that functions regardless of the types of the plurality of master station devices.

4. The slave station system according to claim 1, wherein the first individual function unit includes a manual restoration unit that is a replaceable component; and an automatic restoration unit that automatically restores the component when a failure or an abnormality occurs.

5. The slave station system according to claim 1, further comprising an abnormal signal inflow prevention unit that is located between the plurality of master station devices and the common function unit and prevents abnormal signal inflow to the common function unit.
